(19) United States
(12) Patent Application Publication
(10) Pub. No.: US 2009/0026332 A1
(43) Pub. Date: Jan. 29, 2009

(54) TILT MECHANISM AND ELECTRONIC APPARATUS WITH TILTABLE STAND

(75) Inventors: Shinichi Yoshida, Hachioji-shi (JP); Kenji Nitobe, Hamura-shi (JP); Akira Sugiyama, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/164,538

(22) Filed: Jun. 30, 2008

(30) Foreign Application Priority Data
Jul. 23, 2007 (JP) 2007-191369

(51) Int. Cl. F16M 11/38

(52) U.S. Cl. 248/170

(57) ABSTRACT

According to one embodiment, a tilt mechanism includes a stand with a bottom which is placed on a mounting surface and designed to pass cables therethrough, and a tilt leg supported by the stand. The tilt leg is rotatable between a first position in which the tilt leg is retracted in the stand, and a second position in which the tilt leg downwardly projects from the bottom of the stand. The tilt leg includes a pair of support portions rotatably supported by the bottom, and a bridge portion bridging the support portions and including an edge. The edge opposes the mounting surface when the tilt leg is in the second position. The edge of the bridge portion defines a single recess, through which the cables are led to an outside of the stand.

### CROSS-REFERENCE TO RELATED APPLICATIONS

This application is based upon and claims the benefit of priority from Japanese Patent Application No. 2007-191369, filed Jul. 23, 2007, the entire contents of which are incorporated herein by reference.

### BACKGROUND

1. Field

One embodiment of the invention relates to a tilt mechanism for tilting, using a single tilt leg, a stand from which a plurality of cables are led. Further, the embodiment of the invention relates to an electronic apparatus, such as a telephone, which includes a stand and a main body rotatably supported by the stand, and more particularly to a structure for tilting, using a single tilt leg, a stand from which a plurality of cables are led.

2. Description of the Related Art

Telephones, which are equipped with a main body including dial buttons and a liquid crystal display, and a stand supporting the main body, are now being widely used for general purposes, such as clerical purposes or domestic purposes. Telephones of this type each incorporate a tilt leg at the bottom of their stand as disclosed in, for example, Jpn. Pat. Appln. KOKAI Publication No. 10-4447. The tilt leg is used to tilt a telephone placed on, for example, the top panel of a desk, and is rotatable between a storage position in which the leg is stored in the bottom of the stand, and a use position in which the leg projects from the bottom of the stand.

When the tilt leg is rotated to the use position, it stands between the top panel of the desk and the bottom of the stand to thereby tilt the stand to assume an attitude in which the front side of the stand closer to an operator is lower than the rear side. In this attitude, the dial buttons and liquid crystal display face the operator, whereby the operability of the dial buttons and the visibility of the liquid crystal display are enhanced.

In multi-functional telephones having a large number of extended functions, a plurality of cables, such as connection cables connected to external modules (e.g., a personal computer and external speaker, etc.), a telephone line connection cable and a LAN cable, are led from the bottom of the stand. If the tilt leg is located at a position at which the cables are led out, the cables must be passed around the tilt leg. This inevitably makes tangled the cables led from the bottom of the stand.

Moreover, since the cables are led in random directions from the positions around the tilt leg, the settled telephone with the tangled cables looks horrible.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a telephone according to a first embodiment of the invention, viewed from the front;

FIG. 2 is an exemplary perspective view illustrating the telephone of the first embodiment viewed from the rear;

FIG. 3 is an exemplary sectional view, illustrating a state of the telephone of the first embodiment in which a tilt leg is rotated to a first position;

FIG. 4 is an exemplary perspective view illustrating the telephone of the first embodiment set in the first position and viewed from the bottom of a stand;

FIG. 5 is an exemplary sectional view taken along line F5-F5 of FIG. 4;

FIG. 6 is an exemplary sectional view, illustrating a state of the telephone of the first embodiment in which a tilt leg is rotated to a second position;

FIG. 7 is an exemplary perspective view illustrating the telephone of the first embodiment set in the second position and viewed from the bottom of the stand;

FIG. 8 is an exemplary perspective view illustrating a telephone according to a second embodiment of the invention, viewed from the rear; and

FIG. 9 is an exemplary perspective view illustrating a telephone according to a third embodiment of the invention, viewed from the rear.

### DETAILED DESCRIPTION

Various embodiments according to the invention will be described hereinafter with reference to the accompanying drawings. In general, according to one embodiment of the invention, a tilt mechanism comprises a stand including a bottom which is placed on a mounting surface and designed to pass a plurality of cables therethrough, and a tilt leg supported by the stand. The tilt leg is rotatable between a first position in which the tilt leg is retracted in the stand, and a second position in which the tilt leg downwardly projects from the bottom of the stand. The tilt leg includes a pair of support portions rotatably supported by the bottom of the stand, and a bridge portion bridging the support portions and including an edge. The edge opposes the mounting surface when the tilt leg is in the second position. The edge of the bridge portion defines a single recess through which the cables are led to the outside of the stand.

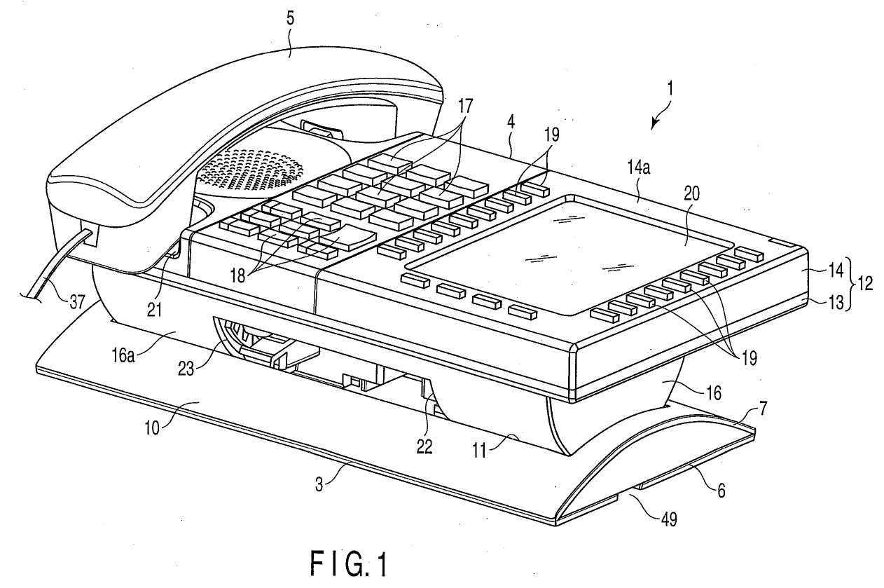

Referring now to FIGS. 1 to 7, a first embodiment of the invention will be described.

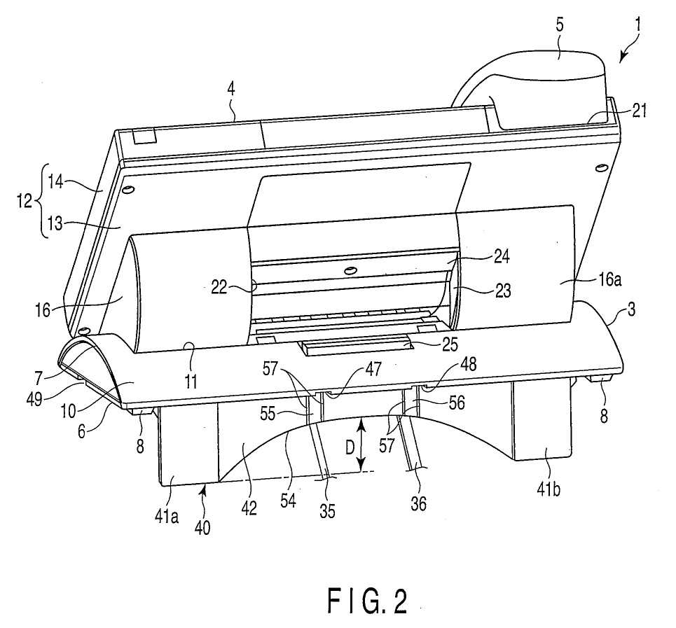

FIGS. 1 and 2 show a telephone 1 as an example of an electronic apparatus according to the first embodiment. The telephone 1 according to the first embodiment is supposed to be used for general purposes, such as clerical purposes and domestic purposes, and can be placed for use on a mounting surface 2, such as the top panel of a desk, or on a wall.

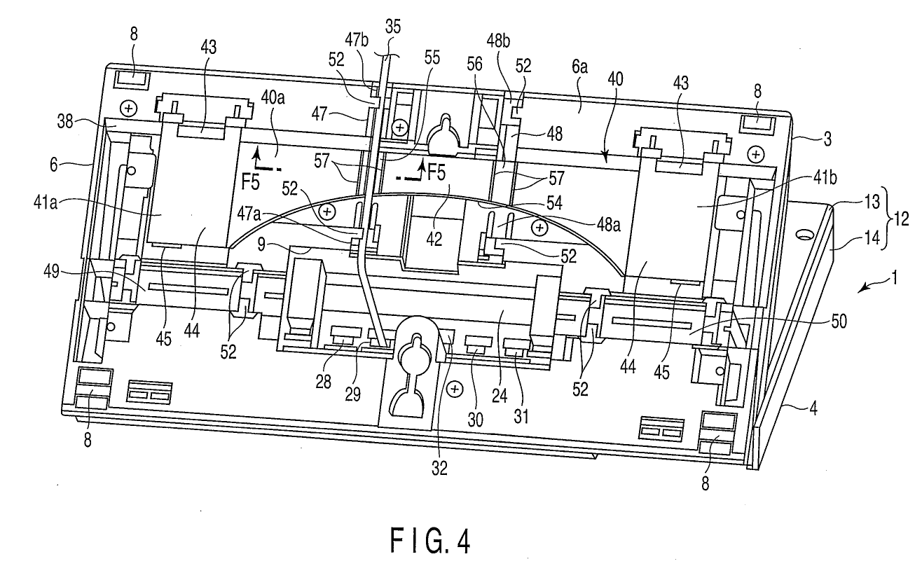

The telephone 1 comprises a stand 3, main body 4 and handset 5. The stand 3 includes a bottom plate 6 and top cover 7. As shown in FIG. 4, the bottom plate 6 includes a rectangular bottom 6a with four corners. The bottom 6a faces the mounting surface 2. Four legs 8 that downwardly project are provided on the four corners of the bottom 6a. The distal ends of the legs 8 are in contact with the mounting surface 2. When the stand 3 is placed on the mounting surface 2, a clearance S is defined by the legs 8 between the bottom 6a and the mounting surface 2. A cable lead-out hole 9 opening to the clearance S is formed in the center portion of the bottom plate 6.

The top cover 7 includes an upper wall 10 covering the bottom plate 6 from above. The upper wall 10 is upwardly warped, and has a rectangular opening 11 at the center thereof. The opening 11 is formed lengthwise in the wall 10 and aligned with the cable lead-out hole 9 of the bottom plate 6.

The main body 4 comprises a flat rectangular casing 12. The casing 12 is formed of a bottom case 13 and top cover 14. The bottom case 13 has a downwardly projecting coupling portion 16. The coupling portion 16 is a semi-cylinder extending widthwise with respect to the main body 4, and has an arcuate outer peripheral surface 16a.

The top cover 14 covers the bottom case 13 from above, and has a flat upper surface 14a. A plurality of dial buttons 17, fixed functional buttons 18, and free assign buttons 19 are provided on the upper surface 14a of the top cover 14. A liquid crystal display panel 20 is also provided on the upper surface 14a of the top cover 14. The liquid crystal display panel 20 is designed to display, for example, telephone numbers, a calendar, time, data transmitted/received states and the content set for the free assign buttons 19.

A handset mounting section 21 is formed at the left end of the upper surface 14a of the top cover 14. A handset 5 is mounted on the handset mounting section 21.

As shown in FIGS. 1 and 2, the coupling portion 16 of the main body 4 has part of the outer peripheral surface 16a inserted in the opening 11 of the stand 3, and is slidably supported by the bottom plate 6 of the stand 3. Further, the coupling portion 16 has a recess 22 formed in the outer peripheral surface 16a. As shown in FIGS. 1 to 3, the recess 22 is defined by a pair of side surfaces 23 (only of them is shown) opposing each other, and a ceiling surface 24. The ceiling surface 23 opposes the opening 11 of the upper wall 10 of the stand 3.

The side surfaces 23 of the coupling portion 16 are swingably supported by the stand 3 via an angle variable mechanism (not shown). In the embodiment, the swing angle of the coupling portion 16 is designed to be adjusted, for example, in five stages in units of 10°. The angle adjustment of the coupling portion 16 is executed by the operator with a lock lever 25 pressed by their finger. The lock lever 25 upwardly projects from behind the opening 11.

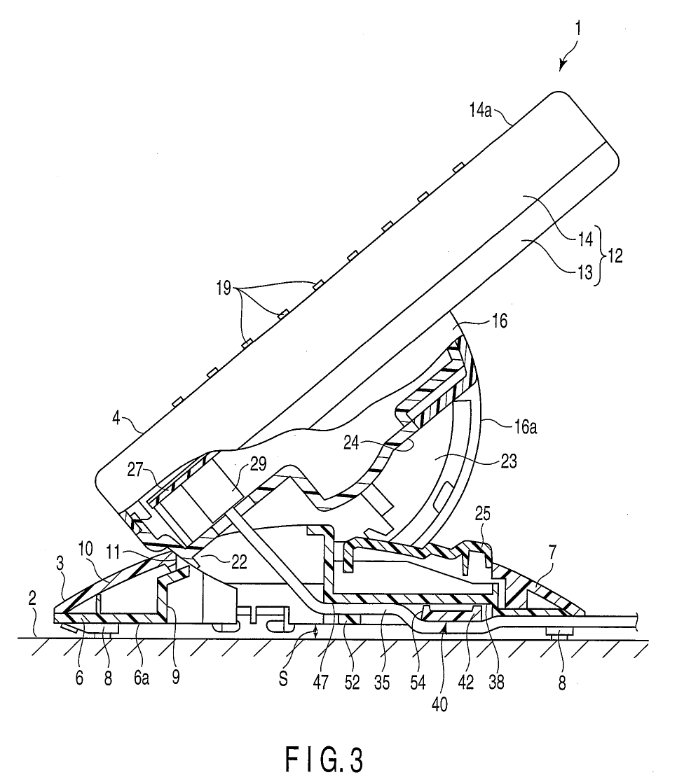

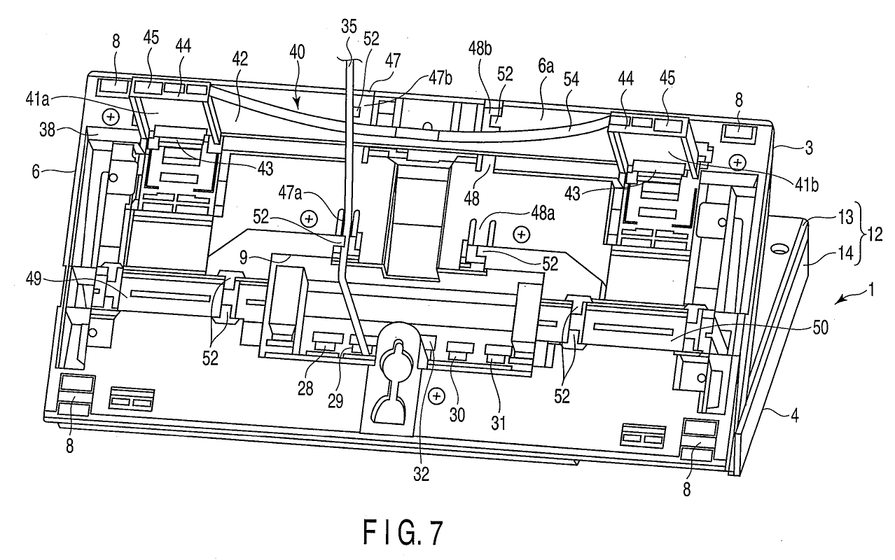

As shown in FIGS. 3 and 6, a printed circuit board 27 is received in the casing 12 of the main body 4. The printed circuit board 27 is disposed parallel to the upper surface 14a of the top cover 14. First to fourth modular jacks 28, 29, 30 and 31 and a single connector 32 are mounted on the lower surface of the front end of the printed circuit board 27 (see FIGS. 4 and 7).

The first to fourth modular jacks 28, 29, 30 and 31 and connector 32 are located in line along the long sides of the main body 4, and are exposed to the recess 22 of the coupling portion 16 through the ceiling surface 24 of the recess 22. Accordingly, the first to fourth modular jacks 28, 29, 30 and 31 and connector 32 oppose the cable lead-out hole 9 formed in the bottom plate 6 of the stand 3 through the opening 11 formed in the upper wall 10 of the stand 3. The connector 32 is interposed between the second and third modular jacks 29 and 30.

The first modular jack 28 is used to connect, for example, an add-on module connection cable (not shown). The second modular jack 29 is used to connect a telephone line connection cable 35. The third modular jack 30 is used to connect, for example, a LAN cable 36. The fourth modular jack 31 is used to connect a handset connection cable 37. The connector 32 is used to connect an external speaker connection cable (not shown). The cables 35, 36 and 37 have different thicknesses or widths, and the LAN cable 36 has a maximum diameter.

The telephone line connection cable 35 connected to the second modular jack 29, and the LAN cable 36 connected to the third modular jack 30 are guided from the ceiling surface 24 of the recess 22 into the stand 3 through the recess 22. Further, the cables 35 and 36 are led out of the inside of the stand 3 to the clearance S, defined between the bottom 6a of the stand 3 and mounting surface 2, through the cable lead-out hole 9.

As shown in FIGS. 4 and 7, a recess 38 is formed in the bottom plate 6 of the stand 3. The recess 38 extends widthwise behind the cable lead-out hole 9, and opens to the bottom 6a of the bottom plate 6.

A tilt leg 40 is attached to the bottom plate 6 of the stand 3. The tilt leg 40 is formed of a flat plate, extending along the rear side of the stand 3.

The tilt leg 40 includes a pair of support portions 41a and 41b and a bridge portion 42.

The support portions 41a and 41b are formed of rectangular plates, and each include first and second ends 43 and 44. The first end 43 of the support portion 41a is supported by one end of a rear portion of the bottom 6a via a hinge (not shown). Similarly, the first end 43 of the support portion 41b is supported by the other end of the rear portion of the bottom 6a via a hinge (not shown). Thus, the support portions 41a and 41b are located near opposite ends of the rear portion of the bottom 6a. Further, the coupling portions of the support portions 41a and 41b and the bottom plate 6 are located along the rear edge of the bottom plate 6 to avoid the recess 38. The second ends 44 of the support portions 41a and 41b are located at the opposite side of the first ends 43. Pads 45 are attached to the tips of the second ends 44 that are brought into direct contact with the mounting surface 2.

The bridge portion 42 of the tilt leg 40 is formed integral with the support portions 41a and 41b to bridge them. In other words, the support portions 41a and 41b are integrally coupled to each other by the bridge portion 42.

By virtue of the above structure, the tilt leg 40 can pivot on the first ends 43 to move between the first and second positions. FIGS. 3 and 4 show the tilt leg 40 set in the first position. In the first position, the tilt leg 40 is made to fall along the bottom 6a of the bottom plate 6 and retracted into the recess 38. The tilt leg 40 is kept in the first position by a lock mechanism (not shown). As shown, in the first position, a flat surface 40a of the tilt leg 40 lies below the stand 3. At this time, the flat surface 40a of the tilt leg 40 is retracted within the recess 38 so as not to project into the clearance S between the bottom 6a of the stand 3 and the mounting surface 2.

FIGS. 6 and 7 show the tilt leg 40 set in the second position. In the second position, the tilt leg 40 stands and downwardly projects from the bottom 6a of the stand 3. The tilt leg 40 is kept in the second position by a lock mechanism (not shown).

Since in the second position, the tilt leg 40 stands between the mounting surface 2 and stand 3 in an attitude in which the surface 40a is directed rearward of the stand 3. Namely, the stand 3 upwardly inclines at a certain angle with its front end kept contact with the mounting surface 2. Accordingly, the operability of the dial buttons 17, fixed function buttons 18 and free assign buttons 19 on the upper surface 14a of the main body 4, and the visibility of the liquid crystal display panel 20 are enhanced.

Further, as shown in FIGS. 4 and 7, the telephone line connection cable 35 led out from the cable lead-out hole 9 is guided through the bottom 6a of the stand 3, and positioned behind the stand 3, regardless of whether the tilt leg 40 is in the first or second position.

First to fourth wiring grooves 47, 48, 49 and 50 are formed in the bottom 6a of the stand 3. These grooves are used to pass therethrough various cables 35, 36 and 37 led out of the cable lead-out hole 9. In the embodiment, each groove has a diameter that enables even the LAN cable 36 of the maximum diameter to be inserted therein.

The first and second wiring grooves 47 and 48 extend lengthwise over the stand 3, between the support portions 41a and 41b of the tilt leg 40, parallel to each other at regular intervals.

As can be seen from FIGS. 4 and 7, the first wiring groove 47 includes a first groove portion 47a positioned adjacent to the cable lead-out hole 9, and a second groove portion 47b positioned at the rear end of the bottom 6a. Similarly, the second wiring groove 48 includes a first groove portion 48a positioned adjacent to the cable lead-out hole 9, and a second groove portion 48b positioned at the rear end of the bottom 6a.

Accordingly, the first groove portions 47a and 48a of the first and second wiring grooves 47 and 48 oppose the second groove portions 47b and 48b of the first and second wiring grooves 47 and 48, respectively, with the bridge portion 42 of the tilt leg 40 interposed therebetween.

The third wiring groove 49 extends from the cable lead-out hole 9 to one short side of the stand 3. The fourth wiring groove 50 extends from the cable lead-out hole 9 to the other short side of the stand 3.

As shown in FIGS. 4 and 7, a plurality of hooks 52 are provided at edges of the first to fourth wiring grooves 47 to 50. The hooks 52 detachably hold various cables in the first to fourth grooves 47 to 50. More specifically, concerning the first wiring groove 47, respective hooks 52 are provided for the first and second groove portions 47a and 47b. Similarly, concerning the second wiring groove 48, respective hooks 52 are provided for the first and second groove portions 48a and 48b.

As shown in FIGS. 2 and 7, the edge of the bridge portion 42 faces the mounting surface 2 when the tilt leg 40 is rotated to the second position. The edge of the bridge portion 42 forms a recess 54. The recess 54 is formed so as not interfere with the cables 35 and 36 led out of the stand 3. The recess 54 bridges the support portions 41a and 41b of the tilt leg 40 and has an arcuate edge. In other words, the depth D of the center of the recess 54 is maximum at the center thereof, and the closer to the support portions 41a and 41b, the shallower the depth D. Thus, the tilt leg 40 is formed arcuate as shown in FIG. 2.

FIGS. 3 and 4 show how the telephone line connection cable 35 is guided when the tilt leg 40 is held in the first position. The cable 35 led from the cable lead-out hole 9 of the stand 3 into the space between the bottom plate 6 and mounting surface 2 is held by the hooks 52 in, for example, the first and second groove portions 47a and 47b of the first wiring groove 47, and guided behind the stand 3. Further, the cable 35 is guided over the surface 40a of the tilt leg 40 set in the first position.

A pair of cable guides 55 and 56 are formed on the surface 40a of the tilt leg 40. The cable guide 55 is located between the first and second groove portions 47a and 47b of the first wiring groove 47. The other cable guide 56 is located between the first and second groove portions 48a and 48b of the second wiring groove 48.

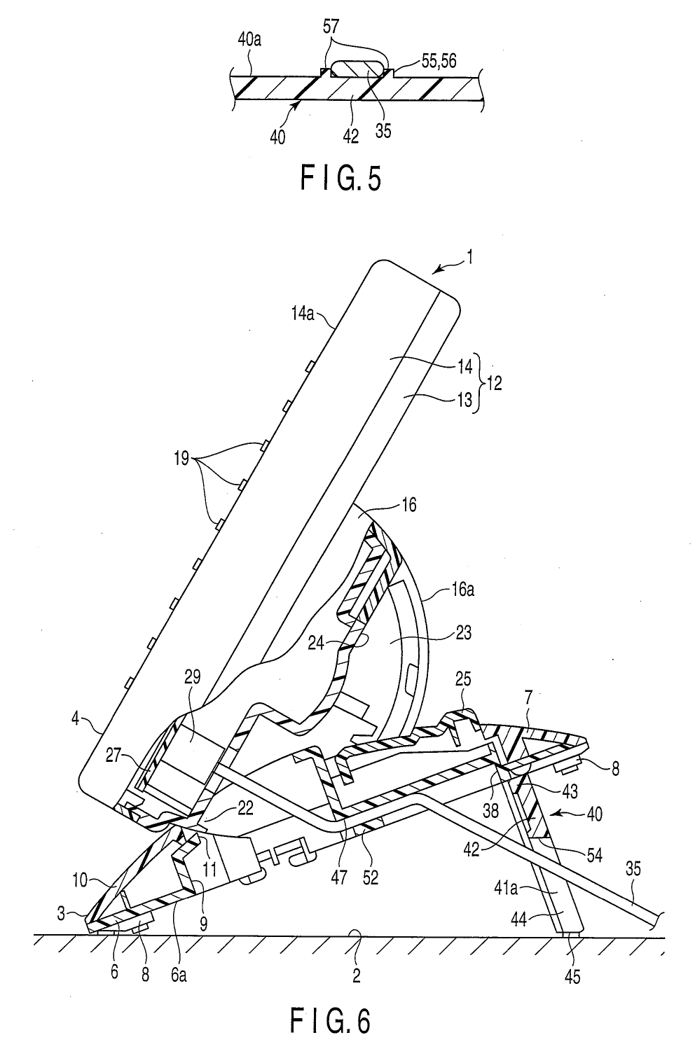

As shown in FIG. 5, the cable guides 55 and 56 are each defined by a pair of ribs 57. The ribs 57 extend along the first and second wiring grooves 47 and 48, spaced from each other and parallel to each other. The distance between the ribs 57 is identical to the width of the first and second groove portions 47a, 47b, 48a and 48b. Further, when the tilt leg 40 is in the first position, there is no step between the tips of the ribs 17 and the bottom 6a of the stand 3.

As a result, when the telephone line connection cable 35 is guided over the surface 40a of the tilt leg 40 set in the first position, it is guided between the ribs 57 from the first groove portion 47a of the first wiring groove 47 to the second groove portion 47b of the same.

FIGS. 6 and 7 show how the telephone line connection cable 35 is guided when the tilt leg 40 is held in the second position. The cable 35 led from the cable lead-out hole 9 of the stand 3 into the space between the bottom plate 6 and mounting surface 2 is held by the hooks 52 in the first groove portion 47a of the first wiring groove 47, and guided behind the stand 3 through the recess 54 of the tilt leg 40.

In the first embodiment of the invention, when the tilt leg 40 is in the second position as shown in FIG. 6, the tilt leg 40 stands between the bottom 6a of the stand 3 and the mounting surface 2. The bridge portion 42 of the tilt leg 40 has the arcuate recess 54 facing the mounting surface 2 and bridging the support portions 41a and 41b of the tilt leg 40.

Accordingly, when, for example, four cables of different thicknesses or widths connected to the first to fourth modular jacks 28 to 31 are guided from the cable lead-out hole 9 below the bottom plate 6 to the position behind the stand 3, they can be arranged through the single recess 54 of the tilt leg 40.

Namely, even when the tilt leg 40 downwardly projects from the bottom 6a of the stand 3, it is not necessary to pass the four cables around the tilt leg 40. The four cables led from the first to fourth modular jacks 28 to 31 to the cable lead-out hole 9 can be directly guided along the bottom plate 6 of the stand 3 to the position behind the stand 3. Thus, wiring can be performed easily.

Further, since the four cables are passed through the recess 54 of the tilt leg 40, it is not necessary to form holes or notches in the tilt leg 40 for individually inserting the cables therein. In particular, the recess 54 employed in the embodiment is curved to bridge the support portions 41a and 41b of the tilt leg 40. Therefore, when the tilt leg 40 is in the second position and is viewed from behind, the bridge portion 42 of the tilt leg 40 looks nice. Thus, the appearance of the tilt leg 40 is not impaired by the cables. Namely, the telephone 1 looks neat even when it is connected to many cables.

In addition, as best shown in FIG. 4, when the tilt leg 40 is in the first position, there is no step between the cable guides 55 and 56 on the surface 40a of the tilt leg 40 and the bottom 6a of the stand 3. In this state, the ribs 57, which form the cable guides 55 and 56 and extend parallel to each other with a gap of the same size as the groove width of the first wiring groove 47, are used as marks for guiding, for example, the telephone line connection cable 35 led from the cable lead-out hole 9.

If there are no ribs, a user, who performs wiring, may be puzzled about how to guide the telephone line connection cable 35, when the tilt leg 40 is in the first position where the tilt leg 40 is interposed between the first and second groove portions 47a and 47b of the first wiring groove 47.

Actually, however, since the ribs 57 exist on the surface 40a of the tilt leg 40 set in the first position, the user can easily understand how the telephone line connection cable 35 should be positioned, and hence easily position the same.

Furthermore, as mentioned above, when the tilt leg 40 is in the first position, there is no step between the cable guides 55 and 56 on the surface 40a of the tilt leg 40 and the bottom 6a of the stand 3. Therefore, even when, for example, attachment fittings for enabling the telephone 1 to be hung on a wall are fixed to the bottom 6a of the stand, the ribs 57 do not interfere with the fittings. Thus, the attachment fittings can be easily fixed to the bottom 6a of the stand 3.

Yet further, when the tilt leg 40 is in the first position, part of the bottom 6a of the stand 3 is covered with the tilt leg 40. Further, since the surface 40a of the tilt leg 40 is retracted inside the bottom 6a of the stand 3, the clearance S between the bottom 6a and mounting surface 2 is not reduced by the tilt leg 40.

This being so, when, for example, the telephone line connection cable 35 is inserted through the clearance S between the bottom 6a and mounting surface 2, the stand 3 is prevented from being raised from the mounting surface 2, whereby the telephone 1 is settled.

The invention is not limited to the above-described first embodiment, but may be modified in various ways without departing form the scope.

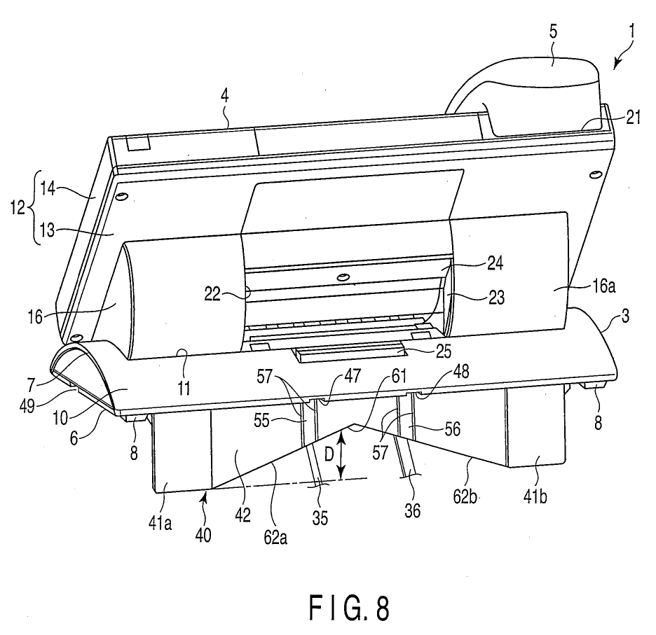

FIG. 8 shows a second embodiment of the invention.

The second embodiment differs from the first embodiment only in the shape of the recess formed in the tilt leg. The other structures of the second embodiment are similar to those of the first embodiment.

As shown in FIG. 8, a recess 61 formed in the tilt leg 40 is defined by first and second linear edges 62a and 62b. The first edge 62a upwardly inclines from the bottom of the support portion 41a to the center of the bridge portion 42, and the second edge 62b upwardly inclines from the bottom of the other support portion 41b to the center of the bridge portion 42. Thus, the first and second edges 62a and 62b contact each other at the center of the bridge portion 42.

Accordingly, the recess 61 is formed like a rectangular notch having its depth D set maximum at the center of the bridge 42.

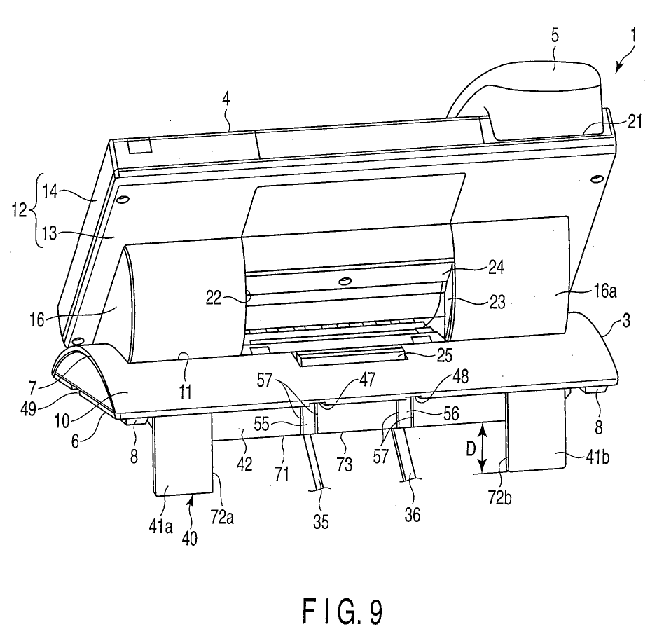

FIG. 9 shows a third embodiment of the invention.

The third embodiment differs from the first embodiment only in the shape of the recess formed in the tilt leg. The other structures of the third embodiment are similar to those of the first embodiment.

As shown in FIG. 9, the recess 71 formed in the tilt leg 40 is defined by a side edge 72a of the support portion 41a, a side edge 72b of the other support portion 41b, and a linear edge 73 bridging the side edges 72a and 72b. The side edges 72a and 72b oppose each other. The linear edge 73 extends parallel to the mounting surface 2. Accordingly, the recess 71 has the same depth D from the mounting surface 2.

Electronic devices including the above-described tilt legs according to the invention are not limited to telephones, but may be other type electronic devices, such as information terminal devices and portable display devices.

While certain embodiments of the inventions have been described, there embodiments have been presented by way of example only, and are not intended to limit the scope of the invention. Indeed, the novel methods and systems described herein may be embodied in a variety of other forms; furthermore various omissions, substitutions and changes in the form of the methods and systems described herein may be made without departing form the spirit of the inventions. The accompanying claims and their equivalents are intended to cover such form or modifications as would fall within the scope and sprit of the inventions.

What is claimed is:

1. A tilt mechanism comprising:
a stand including a bottom which is placed on a mounting surface and designed to pass a plurality of cables therethrough; and
a tilt leg supported by the stand, the tilt leg being rotatable between a first position in which the tilt leg is retracted in the stand, and a second position in which the tilt leg downwardly projects from the bottom of the stand,
wherein:
the tilt leg includes a pair of support portions rotatably supported by the bottom of the stand, and a bridge portion bridging the support portions and including an edge, the edge opposing the mounting surface when the tilt leg is in the second position; and
the edge of the bridge portion defines a single recess, through which the cables are led to an outside of the stand.

2. The tilt mechanism according to claim 1, wherein the recess for passing the cables is defined between the support portions of the tilt leg.

3. The tilt mechanism according to claim 1, wherein the recess of the tilt leg has a depth thereof varied along the bridge portion such that the depth is maximum at a center of the bridge portion between the support portions.

4. The tilt mechanism according to claim 3, wherein the edge of the bridge portion defining the recess of the tilt leg is arcuate.

5. The tilt mechanism according to claim 1, wherein when the tilt leg is in the first position, the tilt leg is retracted inside the stand such that the tilt leg does not project from the bottom of the stand.

6. The tilt mechanism according to claim 1, wherein the bottom of the stand includes a plurality of grooves which are formed in portions thereof opposing each other with the bridge portion interposed therebetween, and are used to guide the cables, the bottom further including a plurality of hooks used to detachably hold the cables in the grooves.

7. The tilt mechanism according to claim 6, wherein the bridge portion of the tilt leg includes a flat surface and a plurality of cable guides provided on the surface, the cable guides being positioned between and aligned with the grooves to guide the cables, with no step formed between the flat surface and the bottom of the stand, when the tilt leg is in the first position.

8. The tilt mechanism according to claim 7, wherein the cable guides are formed of a pair of ribs projecting from the flat surface of the bridge portion, no step being formed between tips of the ribs and the bottom of the stand when the tilt leg is in the first position.

9. An electronic apparatus comprising:
a main body including a stand provided with a bottom, the bottom being placed on a mounting surface and designed to pass a plurality of cables therethrough; and
a tilt leg supported on the stand, the tilt leg being rotatable between a first position in which the tilt leg is retracted in the stand, and a second position in which the tilt leg downwardly projects from the bottom of the stand,
wherein:
the tilt leg includes a pair of support portions rotatably supported by the bottom of the stand, and a bridge portion bridging the support portions and including an edge, the edge opposing the mounting surface when the tilt leg is in the second position; and
the edge of the bridge portion defines a single recess, through which the cables are led to an outside of the stand.

10. The electronic apparatus according to claim 9, wherein when the tilt leg is in the first position, the tilt leg is retracted inside the stand such that the tilt leg does not project from the bottom of the stand.

11. The electronic apparatus according to claim 9, wherein the bottom of the stand includes a plurality of grooves which are formed in portions thereof opposing each other with the bridge portion interposed therebetween, and are used to guide the cables, the bottom further including a plurality of hooks used to detachably hold the cables in the grooves.

12. The electronic apparatus according to claim 11, wherein the bridge portion of the tilt leg includes a flat surface and a plurality of cable guides provided on the surface, the cable guides being positioned between and aligned with the grooves to guide the cables, with no step formed between the flat surface and the bottom of the stand, when the tilt leg is in the first position.

13. The electronic apparatus according to claim 9, wherein the edge of the bridge portion defining the recess of the tilt leg is arcuate.
